(19) United States
(12) Patent Application Publication
(10) Pub. No.: US 2011/0100877 A1
(43) Pub. Date: May 5, 2011

(54) Method and device for automated control of enhanced metal and amine removal from crude oil

(75) Inventor: Peter Snawerdt, West Melbourne, FL (US)

(73) Assignee: Assateague Oil Ilc, West Melbourne, FL (US)

(21) Appl. No.: 12/590,231

(22) Filed: Nov. 4, 2009

(51) Int. Cl. C10G 17/04; C10C 3/08; G05B 21/00

(52) U.S. Cl. 208/178; 196/14.52; 700/272

(57) ABSTRACT

A method for removing calcium, iron, other metals, and amines from crude oil in a refinery desalting process includes the steps of adding a wash water to the crude oil; adding the wash water to the crude oil to create an emulsion; adding to the wash water, the crude oil or the emulsion an acid additive consisting of at least one of the following: oxalic acid, citric acid, water-soluble hydroxyacid selected from the group consisting of glycolic acid, gluconic acid, C.sub.2-C.sub.4 alpha-hydroxy acids, malic acid, lactic acid, poly-hydroxy carboxylic acids, thioglycolic acid, chloroacetic acid, polymeric forms of the above hydroxyacids, poly-glycolic esters, glycolate ethers, and ammonium salt and alkali metal salts of these hydroxyacids, and mixtures thereof; heating at least one of the crude oil, the wash water or the emulsion to a desired temperature; resolving the emulsion containing the acid additive into a hydrocarbon phase and an aqueous phase using electrostatic coalescence, the metals and amines being transferred to the aqueous phase; measuring at least one desalting process characteristic at at least one process point; performing a statistical calculation of the desalting process performance based upon the measuring; and adjusting a control setting of the desalting process as a function of the statistical calculation. Other methods and devices are also provided.

### FIELD OF THE INVENTION

The present invention relates to a method and device for removing metals, amines, and other contaminants from crude oil and, more particularly, to automated control of the device and method for use in an oil refinery and to an oil refinery for employing such methods.

### BACKGROUND INFORMATION

U.S. Pat. No. 4,853,109 discloses a method for removing metal contaminants, particularly iron and non-porphyrin, organically-bound iron components from crude petroleum. This process comprises mixing crude oil with an aqueous solution of hydroxo-carboxylic acids or salts thereof, preferably citric acid, and separating the aqueous solution and metals from the crude.

U.S. Pat. 5,078,858 discloses a method for extracting iron species from crude oil by directly adding oxalic or citric acid to the crude oil feedstock, mixing the acid and oil, then adding wash water to form a water in oil emulsion. The emulsion is resolved separating the aqueous solution and metals from the crude.

U.S. Pat. No. 7,497,943 discloses a method for transferring metals and/or amines from a hydrocarbon phase to a water phase in an oil refinery desalting process. The method consists of adding to a wash water an effective amount of a composition comprising certain water-soluble hydroxyacids to transfer metals and/or amines from a hydrocarbon phase to a water phase. The water-soluble hydroxyacid is, selected from the group consisting of glycolic acid, gluconic acid, C.sub.2-C.sub.4 alpha-hydroxyacids, malic acid, lactic acid, poly-hydroxy carboxylic acids, thioglycolic acid, chloroacetic acid, polymeric forms of the above hydroxyacids, poly-glycolic esters, glycolate ethers, ammonium salt and alkali metal salts of these hydroxyacids, and mixtures thereof. The pH of the wash water is lowered to 6 or below, before, during and/or after adding the composition and the wash water is added to crude oil to create an emulsion. Finally, the emulsion is resolved into the hydrocarbon phase and an aqueous phase using electrostatic coalescence, where at least a portion of the metals and/or amines are transferred to the aqueous phase.

Optimum Temperature in the Electrostatic Desalting of Maya Crude Oil by Pruneda et al published in the 2005 Journal of the Mexican Chemical Society discloses a simulation model which suggests that there is an optimum temperature to maximize economic benefit when desalting heavy crude oil. As indicated in the art, an increase in process temperature has two effects to be considered. First, as temperature is increased, there is a corresponding decrease in oil density and viscosity which implies a significant increase in the settling rate of water droplets within the oil phase thus allowing a greater amount of oil to be processed resulting in an increase in profit from performing oil desalting. However, crude oil conductivity increases exponentially with temperature which implies a higher rate of electrical power consumption during electrostatic coalescence which increases processing expense.

Basic Statistics by Kiemele et al published in 1991 discloses statistical process control techniques whereby data is collected on a manufacturing or industrial process, statistics are computed on the data, and human operators interpret the results. In the process outlined by Kiemele et al, all decision-making and process change operations are made by a human operator.

U.S. Pat. No. 4,853,109, U.S. Pat. No. 5,078,858, U.S. Pat. No. 7,497,943, Optimum Temperature in the Electrostatic Desalting of Maya Crude Oil by Pruneda et al, and Basic Statistics by Kiemele et al are hereby incorporated by reference herein.

### SUMMARY OF THE INVENTION

The present invention provides a method for removing calcium, iron, other metals, and amines from crude oil in a refinery desalting process comprising the steps of: adding a wash water to the crude oil; adding the wash water to the crude oil to create an emulsion; adding to the wash water, the crude oil or the emulsion an acid additive consisting of at least one of the following: oxalic acid, citric acid, water-soluble hydroxyacid selected from the group consisting of glycolic acid, gluconic acid, C.sub.2-C.sub.4 alpha-hydroxy acids, malic acid, lactic acid, poly-hydroxy carboxylic acids, thioglycolic acid, chloroacetic acid, polymeric forms of the above hydroxyacids, poly-glycolic esters, glycolate ethers, and ammonium salt and alkali metal salts of these hydroxyacids, and mixtures thereof; heating at least one of the crude oil, the wash water or the emulsion to a desired temperature; resolving the emulsion containing the acid additive into a hydrocarbon phase and an aqueous phase using electrostatic coalescence, the metals and amines being transferred to the aqueous phase; measuring at least one desalting process characteristic at at least one process point; performing a statistical calculation of the desalting process performance based upon the measuring; and adjusting a control setting of the desalting process as a function of the statistical calculation.

The present invention also provides a method for controlling a refinery desalting process comprising the steps of: measuring at least one desalting process characteristic at at least one process point; performing a statistical calculation of the desalting process performance based upon the measuring; and adjusting a control setting of the desalting process as a function of the statistical calculation.

The present invention also provides a crude oil refinery operating the present methods, as well as an electrostatic desalter comprising: a crude oil supply for storing crude oil; a wash water supply for supplying wash water to the crude oil to form an emulsion; an acid additive supply for supplying an acid additive to the wash water, the emulsion, or the crude oil; a heater for changing the temperature of the crude oil, the wash water or the emulsion; pumps and valves for controlling fluid flow in the desalting process; and a controller monitoring a desalter process characteristic and updating a statistical calculation of the desalter performance based upon the monitoring.

### BRIEF DESCRIPTION OF THE DRAWINGS

FIG. 1 shows a block diagram of a typical single stage crude oil electrostatic desalting mechanism according to one embodiment of the present invention;

FIG. 2 shows a block diagram of a typical first stage dehydration followed by a second stage electrostatic desalting mechanism according to one embodiment of the present invention;

FIG. 3 shows a block diagram of a typical two stage electrostatic desalting mechanism according to one embodiment of the present invention;

FIG. 4 shows an algorithm diagram of one embodiment of the control methods of the present invention for a typical crude oil electrostatic desalting operation.

FIG. 5 shows a diagram of one embodiment of the method of the present invention for a typical crude oil desalting operation.

### DETAILED DESCRIPTION

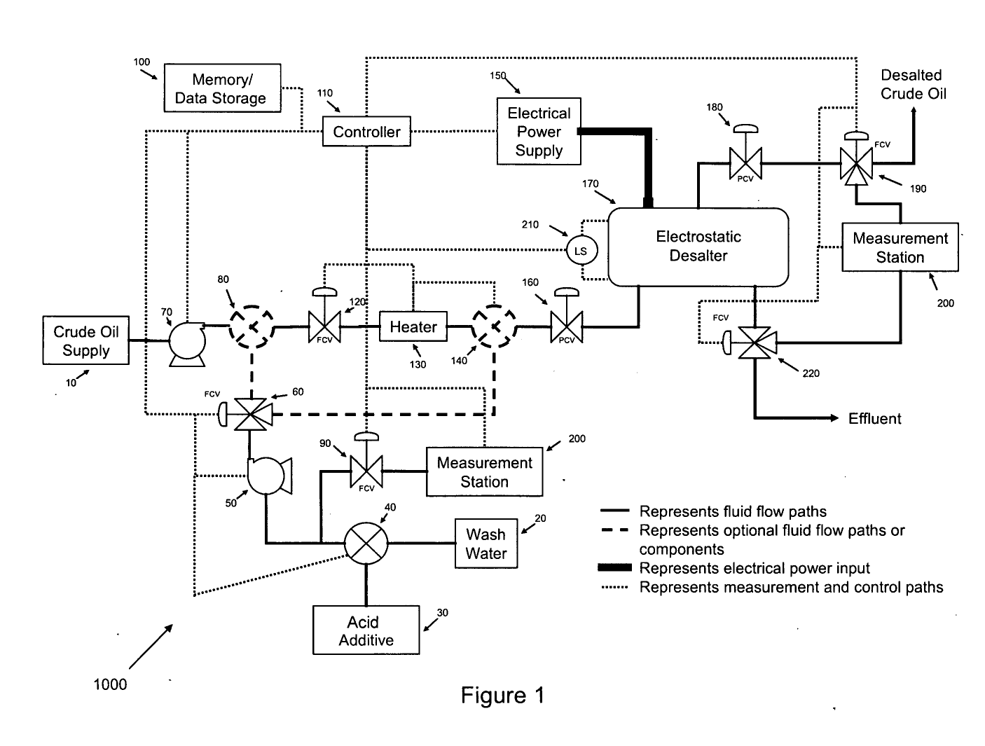

FIG. 1 shows a diagram of a single stage crude oil electrostatic desalting mechanism 1000 of the present invention.

The desalting mechanism 1000 of the present invention includes a crude oil supply 10 for storing crude oil. The crude oil supply 10 is connected to a controllable pump 70 which is connected to an optional controllable fluid mixer 80. The optional controllable fluid mixer 80 allows an emulsion of crude oil 10, wash water 20, and acid additive 30 to be created prior to heating based upon the specific characteristics of the crude oil supply 10 to be desalted. The optional controllable fluid mixer 80, if necessary to process the crude oil supply 10, is controlled by the controller 110 to create and maintain the proper emulsion mix of crude oil 10, wash water 20, and acid additive 30.

Following either the controllable pump 70 or the optional controllable fluid mixer 80 is a controllable flow control valve (FCV) 120. The controllable flow control valve 120 and the controllable pump 70 work in conjunction under command of the controller 110 to control and maintain the crude oil feed rate and pressure. The crude oil 10 or crude oil emulsion created via optional controllable fluid mixer 80 is then heated to a desired processing temperature by the heater 130 which is controlled by controller 110.

The desalting mechanism 1000 of the present invention also includes a wash water supply 20 and an acid additive supply 30. In the embodiment of FIG. 1, as is preferred, the acid additive 30 is mixed with the wash water 20 by the controllable fluid mixer 40 before the crude oil/wash water emulsion is formed. Alternatively, the acid additive 30 could be mixed with the wash water 20 and crude oil 10 during the emulsion creation or after water-oil emulsion creation or with the crude oil 10 itself. The fluid mixer 40 is controlled by the controller 110 to create and maintain the proper solution mixture of acid additive 30 and wash water 20. The acid additive 30 can be selected from the group consisting of oxalic acid, citric acid, glycolic acid, gluconic acid, C.sub.2-C.sub.4 alpha-hydroxy acids, malic acid, lactic acid, poly-hydroxy carboxylic acids, thioglycolic acid, chloroacetic acid, polymeric forms of the above hydroxyacids, poly-glycolic esters, glycolate ethers, and ammonium salt and alkali metal salts of these hydroxyacids, and mixtures thereof.

After mixing the solution of acid additive 30 and wash water 20 with the controllable fluid mixer 40, the resulting solution is input to a controllable flow control valve 90 which is used to allow samples of the mixed acid additive 30 and wash water 20 solution to be measured at a measurement station 200. Measurements made on the solution samples would include but not be limited to solution pH, solution impurity levels, and percentage of acid additive 30 to wash water 20. This information is sent to the controller 110.

After mixing the solution of acid additive 30 and wash water 20 with the controllable fluid mixer 40, the resulting solution is also input to a controllable pump 50 whose output is connected to a controllable flow control valve 60. The controllable pump 50 and the flow control valve 60 work in conjunction under the command of the controller 110 to control and maintain the wash water/acid solution feed rate and pressure. In the embodiment of FIG. 1, the controllable flow control valve 60 is shown to be a three-way valve to allow for emulsion creation with the crude oil supply 10 via the optional controllable fluid mixer 80, the optional controllable fluid mixer 140, or both. Like the optional controllable fluid mixer 80, the optional controllable fluid mixer 140, if necessary to process the crude oil supply 10, is controlled by the controller 110 to create and maintain the proper emulsion mix of crude oil 10, wash water 20, and acid additive 30. The controllable flow control valve 60 also allows for the acid additive 30 and wash water 20 solution to be presented to the optional controllable fluid mixer 80 and optional controllable fluid mixer 140 at the same or different flow rates when both mixer devices are used in the desalting process.

Following the optional controllable fluid mixer 140, the emulsion passes through a pressure control valve 160 before entering the electrostatic desalter 170. The electrostatic desalter 170 includes a liquid level sensor (LS) 210 used to measure the aqueous level in the electrostatic desalter 170. In the embodiment of FIG. 1, the measurement output of the liquid level sensor 210 is routed to the controller 110. The controller 110 uses the liquid level measurement data to control the controllable flow control valve 220 to drain the effluent from the electrostatic desalter 170 and control the aqueous layer and emulsion layer within the electrostatic desalter 170. Alternatively, the liquid level sensor 210 output may be directly connected to a level control valve instead of the controllable flow control valve 220 to drain the effluent. The controllable flow control valve 220 is also configured to allow samples of the effluent solution to be measured at a measurement station 200. Measurements made on the solution samples would include but not be limited to solution pH, solution impurity levels, temperature, and amount of residual oil present in the effluent. This information is sent to the controller 110.

The electrical power supply 150 provides the voltage necessary to create the electric field necessary for electrostatic coalescence in the electrostatic desalter 170. The controller 110 controls the electrical power supply 150 output. The electrical power supply 150 output may be static (i.e. constant voltage with a current limit) or, preferably, able to change key parameters to enhance the desalting operation. The electrical power supply 150 under the control of the controller 110 would preferably be able to alter its' output to include but not be limited to changes in the voltage level applied to the electrostatic desalter 170, the voltage waveform applied to the electrostatic desalter 170, current limits (if any) on the electrical power supply 150, or any combination thereof.

The desalted crude output of the electrostatic desalter 170 passes through a pressure control valve 180 and a controllable flow control valve 190. The controllable flow control valve 190 has two outputs to direct the desalted crude oil. Under control of the controller 110, the controllable flow control valve 190 controls and maintains the flow rate of desalted crude oil to the remaining refinery operations. Additionally, under control of the controller 110, the controllable flow control valve 190 can also direct samples of the desalted crude to the measurement station 200. Measurements made on the solution samples would include but not be limited to impurity levels, temperature, residual acid additive 30 and wash water 20 solution, etc. This information is sent to the controller 110.

In the embodiment of FIG. 1, the controller 110 collects measurements from process points including but not limited to the various points described herein to evaluate the efficiency of the desalting mechanism 1000. The measurement points can be divided into two data types: intra-process data and product data. Intra-process data include factors that have an impact in the results of the final product, but are not measurements of the final product. Product data are measurements of the final product.

In the embodiment of FIG. 1, the controller 110 collects measurements from a number of intra-process data points including but not limited to the following:

The crude oil supply 10 feed rate through the flow control valve 120

The temperature, viscosity, and density of the crude oil supply 10 or, optionally, the emulsion created by mixing the crude oil supply with a solution comprising the acid additive 30 or acid additive 30 and wash water 20 through the controllable heater 130.

The acid additive 30 and wash water 20 feed rate through the controllable flow control valve 60.

The characteristics of the solution mixture of acid additive 30 and wash water 20 through the controllable flow control valve 90 and measurement station 200. Specific measurements may include but not be limited to the percentage of acid additive in the solution, other impurities present either in the wash water 20 or acid additive 30, etc.

The electrostatic desalter 170 water level and emulsion layer through the liquid level sensor 210.

The characteristics of the electrostatic desalter 170 effluent through the controllable flow control valve 220 and the measurement station 200.

The characteristics of the electrostatic desalter 170 electric field through the electrical power supply 150. Specific measurements may include but not be limited to peak voltage, peak current, RMS current, RMS voltage, current limit, etc.

The intra-process measurements made under the control of the controller 110 are made at random or, preferably, regular intervals while processing the crude supply 10. If the desalting process includes a customer specification for any intra-process measurement, each applicable measurement is compared to the specification to determine if the sample is within the customer required limits. If the specification is not met, immediate corrective action is taken as per the customers' requirement.

The intra-process data measurements made under the control of the controller 110 are used under the present invention to compute statistical quantifiers for use by the controller 110 to signal potential problems with and control the electrostatic desalter mechanism 1000. The data measurements are classified as either binary or continuous. Examples of a binary data set include a pass or fail criteria. Continuous data includes measurements such as temperature, pressure, voltage, etc.

In the embodiment of FIG. 1, the controller 110 collects measurements of the desalted crude oil output product through the controllable flow control valve 190 and the measurement station 200. The product measurements made under the control of the controller 110 are made at random or, preferably, regular intervals. If the desalting process includes a customer specification for any measurement either individually or in combination with others, each applicable measurement is compared to the specification to determine if the sample is within the customer required limits. If the specification is not met, immediate corrective action is taken per the customers' requirements. The product data measurements made under the control of the controller 110 are also used under the present invention to compute statistical quantifiers for use by the controller 110 to signal potential problems with and control the electrostatic desalter mechanism 1000. The product data measurements are classified as either binary or continuous in the same manner as the intra-process data measurements.

Based upon the type of crude oil being processed, the controller 110 can adjust various factors of the desalting operation including but not limited to the following:

The crude oil supply 10 feed rate through the controllable pump 70 and controllable flow control valve 120

The temperature of the crude oil supply 10 or, optionally, the emulsion created by mixing the crude oil supply 10 with a solution comprising the acid additive 30 and/or wash water 20 through the controllable heater 130.

The solution mixture of acid additive 30 and wash water 20 through the controllable fluid mixer 40.

The flow rate of the solution mixture of acid additive 30 and wash water 20 through the controllable pump 50 and controllable flow control valve 60.

The emulsion formation through optional controllable fluid mixer 80 and/or optional controllable fluid mixer 140.

The electrostatic desalter 170 electric field through the controllable electrical power supply 150.

Control of the electrostatic desalter water level and emulsion layers through the liquid level sensor 210, the controllable flow control valve 220, and the controllable flow control valve 190.

As different crude oils are processed by the desalting mechanism 1000, the characteristics necessary to efficiently desalt the crude oil will require some adjustment. Additionally, differences in electrostatic desalter 170 characteristics, wash water supply 20 purity, etc. between different desalting mechanisms 1000 require the storage of different control settings. The memory/data storage 100 function of the desalting mechanism 1000 allows the controller to access and update, if required, the control settings required to efficiently process various types of crude oil supplies 10.

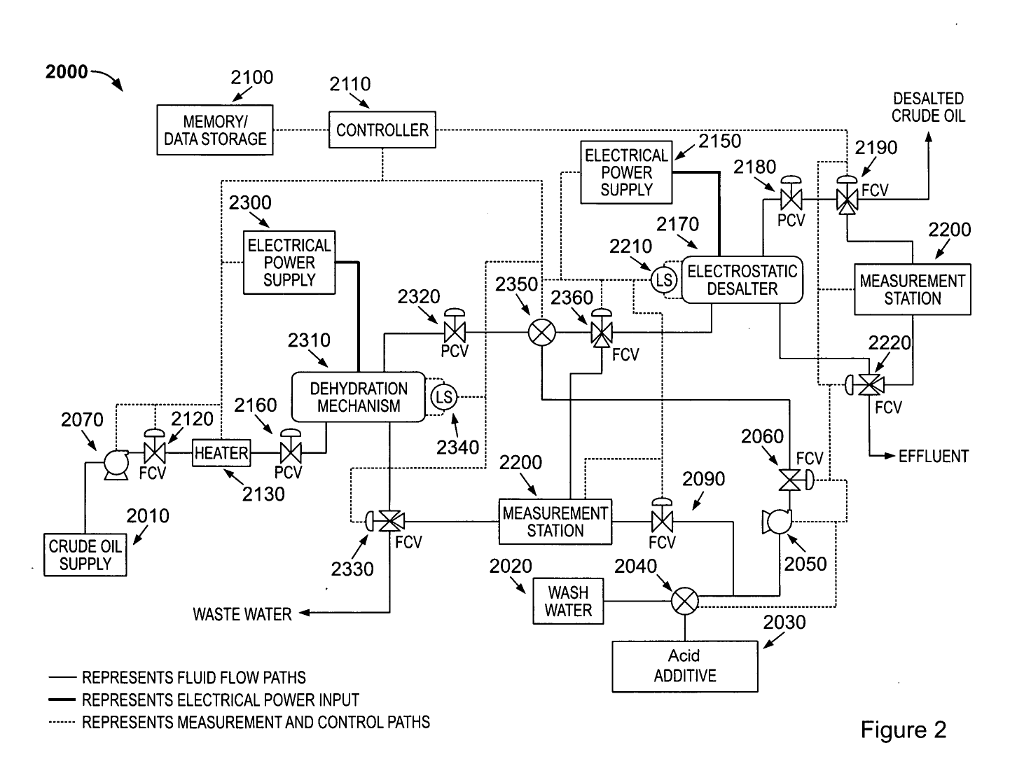

FIG. 2 shows a diagram of a typical first stage dehydration followed by a second stage electrostatic desalting mechanism 2000 of the present invention.

The desalting mechanism 2000 of the present invention includes a crude oil supply 2010 for storing crude oil. The crude oil supply 2010 is connected to a controllable pump 2070 whose output is connected to a controllable flow control valve (FCV) 2120. The controllable flow control valve 2120 and the controllable pump 2070 work in conjunction under command of the controller 2110 to control and maintain the crude oil feed rate and pressure. The crude oil 2010 is then heated to a desired processing temperature by the heater 2130 which is controlled by controller 2110. In the embodiment of FIG. 2, the heated crude oil passes through a pressure control valve 2160 before entering the dehydration mechanism 2310. The dehydration mechanism 2310 is designed to remove high salinity water from the crude oil supply 2010. The dehydration process relies on establishing a varying high voltage electric field in the oil phase of the dehydration mechanism 2310. Due to the action of the imposed electric field, the droplets are agitated causing the drops to coalesce into droplets of sufficient size to migrate via gravity to the lower water phase of the dehydration mechanism 2310. The dehydration mechanism 2310 includes a liquid level sensor (LS) 2340 used to measure the water level in the dehydration mechanism 2310. In the embodiment of FIG. 2, the measurement output of the liquid level sensor 2340 is routed to the controller 2110. The controller 2110 uses the liquid level measurement data to control the controllable flow control valve 2330 to drain the waste water from the dehydration mechanism 2310 and control the water layer and oil layer within the dehydration mechanism 2310. Alternatively, the liquid level sensor 2340 output may be directly connected to a level control valve instead of the controllable flow control valve 2330 to drain the waste water. The controllable flow control valve 2330 is also configured to allow samples of the effluent solution to be measured at a measurement station 2200. Measurements made on the solution samples would include but not be limited to solution pH, solution impurity levels, temperature, and amount of residual oil present in the waste water. This information is sent to the controller 2110.

The electrical power supply 2300 provides the voltage necessary to create the electric field necessary for water coalescence in the dehydration mechanism 2310. The controller 2110 controls the electrical power supply 2300 output. The electrical power supply 2300 output may be static (i.e. constant voltage with a current limit) or, preferably, able to change key parameters to enhance the dehydration operation. The electrical power supply 2300 under the control of the controller 2110 would preferably be able to alter its' output to include but not be limited to changes in the voltage level applied to the dehydration mechanism 2310, the voltage waveform applied to the dehydrator, current limits (if any) on the electrical power supply 2300, or any combination thereof.

The crude output of the dehydration mechanism 2310 passes through a pressure control valve 2320 on its way to the controllable fluid mixer 2350. The controllable fluid mixer 2350 allows an emulsion of crude oil 2010, wash water 2020, and acid additive 2030 to be created based upon the specific characteristics of the crude oil supply 2010 to be desalted. The controllable fluid mixer 2350 is controlled by the controller 2110 to create and maintain the proper emulsion mix of crude oil 2010, wash water 2020, and acid additive 2030.

The desalting mechanism 2000 of the present invention also includes a wash water supply 2020 and a acid additive supply 2030. In the embodiment of FIG. 2, as is preferred, the acid additive 2030 is mixed with the wash water 2020 by the controllable fluid mixer 2040 before the crude oil/wash water emulsion is formed. Alternatively, the acid additive 2030 could be mixed with the wash water 2020 and crude oil 2010 during the emulsion creation or after emulsion creation or with the crude oil 2010 itself. The fluid mixer 2040 is controlled by the controller 2110 to create and maintain the proper solution mixture of acid additive 2030 and wash water 2020. The acid additive 2030 can be selected from the group consisting of oxalic acid, citric acid, glycolic acid, gluconic acid, C.sub.2-C.sub.4 alpha-hydroxy acids, malic acid, lactic acid, poly-hydroxy carboxylic acids, thioglycolic acid, chloroacetic acid, polymeric forms of the above hydroxyacids, poly-glycolic esters, glycolate ethers, and ammonium salt and alkali metal salts of these hydroxyacids, and mixtures thereof.

After mixing the solution of acid additive 2030 and wash water 2020 with the controllable fluid mixer 2040, the resulting solution is input to a controllable flow control valve 2090 which is used to allow samples of the mixed acid additive 2030 and wash water 2020 solution to be measured at a measurement station 2200. Measurements made on the solution samples would include but not be limited to solution pH, solution impurity levels, and percentage of acid additive 2030 to wash water 2020. This information is sent to the controller 2110.

After mixing the solution of acid additive 2030 and wash water 2020 with the controllable fluid mixer 2040, the resulting solution is also input to a controllable pump 2050 whose output is connected to a controllable flow control valve 2060. The controllable pump 2050 and the flow control valve 2060 work in conjunction under the command of the controller 2110 to control and maintain the wash water/acid solution feed rate and pressure. The output of the flow control valve 2060 is an input to the controllable fluid mixer 2350 where the emulsion of crude oil 2010, wash water 2020, and acid additive 2030 is formed.

After mixing the crude oil 2010, acid additive 2030, and wash water 2020 in the controllable fluid mixer 2350, the resulting emulsion passes through a controllable flow control valve 2360 before entering the electrostatic desalter 2170. The controllable flow control valve 2360, under command of the controller 2110, controls the flow rate of the crude oil emulsion into the electrostatic desalter 2170 as well as allowing samples of the emulsion to be directed to the measurement station 2200. Measurements made on the solution samples would include but not be limited to impurity levels, temperature, amount of acid additive 2030 and wash water 2020 solution, etc. This information is sent to the controller 2110.

The electrostatic desalter 2170 includes a liquid level sensor (LS) 2210 used to measure the aqueous level in the electrostatic desalter 2170. In the embodiment of FIG. 2, the measurement output of the liquid level sensor 2210 is routed to the controller 2110. The controller 2110 uses the liquid level measurement data to control the controllable flow control valve 2220 to drain the effluent from the electrostatic desalter 2170 and control the aqueous layer and emulsion layer within the electrostatic desalter 2170. Alternatively, the liquid level sensor 2210 output may be directly connected to a level control valve instead of the controllable flow control valve 2220 to drain the effluent. The controllable flow control valve 2220 is also configured to allow samples of the effluent solution to be measured at a measurement station 2200. Measurements made on the solution samples would include but not be limited to solution pH, solution impurity levels, temperature, and amount of residual oil present in the effluent. This information is sent to the controller 2110.

The electrical power supply 2150 provides the voltage necessary to create the electric field necessary for electrostatic coalescence in the electrostatic desalter 2170. The controller 2110 controls the electrical power supply 2150 output. The electrical power supply 2150 output may be static (i.e. constant voltage with a current limit) or, preferably, able to change key parameters to enhance the desalting operation. The electrical power supply 2150 under the control of the controller 2110 would preferably be able to alter its' output to include but not be limited to changes in the voltage level applied to the electrostatic desalter 2170, the voltage waveform applied to the electrostatic desalter 2170, current limits (if any) on the electrical power supply 2150, or any combination thereof.

The desalted crude output of the electrostatic desalter 2170 passes through a pressure control valve 2180 and a controllable flow control valve 2190. The controllable flow control valve 2190 has two outputs to direct the desalted crude oil. Under control of the controller 2110, the controllable flow control valve 2190 controls and maintains the flow rate of desalted crude oil to the remaining refinery operations. Additionally, under control of the controller 2110, the controllable flow control valve 2190 can also direct samples of the desalted crude to the measurement station 2200. Measurements made on the solution samples would include but not be limited to impurity levels, temperature, residual acid additive 2030 and wash water 2020 solution, etc. This information is sent to the controller 2110.

In the embodiment of FIG. 2, the controller 2110 takes measurements including but not limited to the various points described herein to evaluate the efficiency of the desalting mechanism 2000. The measurement points can be divided into two data types: intra-process data and product data. Intra-process data include factors that have an impact in the results of the final product, but are not measurements of the final product. Product data are measurements of the final product.

In the embodiment of FIG. 2, the controller 2110 collects measurements from a number of intra-process data points including but not limited to the following:

The crude oil supply 2010 feed rate through the flow control valve 2120.

The temperature, viscosity, and density of the crude oil supply 2010 through the controllable heater 2130.

The dehydration mechanism 2310 water level and emulsion layer through the liquid level sensor 2340.

The characteristics of the dehydration mechanism 2310 waste water through the controllable flow control valve 2330 and the measurement station 2200.

The characteristics of the dehydration mechanism 2310 electric field through the electrical power supply 2300.

The acid additive 2030 and wash water 2020 feed rate through the controllable flow control valve 2060.

The characteristics of the solution mixture of acid additive 2030 and wash water 2020 through the controllable flow control valve 2090 and measurement station 2200.

The characteristics of the wash water 2020/acid additive 2030/crude oil 2010 emulsion through the controllable flow control valve 2360 and measurement station 2200.

The electrostatic desalter 2170 water level and emulsion layer through the liquid level sensor 2210.

The characteristics of the electrostatic desalter 2170 effluent through the controllable flow control valve 2220 and the measurement station 2200.

The characteristics of the electrostatic desalter 2170 electric field through the electrical power supply 2150.

The intra-process measurements made under the control of the controller 2110 are made at random or, preferably, regular intervals while processing the crude supply 2010. If the desalting process includes a customer specification for any intra-process measurement, each applicable measurement is compared to the specification to determine if the sample is within the customer required limits. If the specification is not met, immediate corrective action is taken as per the customers' requirement.

The intra-process data measurements made under the control of the controller 2110 are used under the present invention to compute statistical quantifiers for use by the controller 2110 to signal potential problems with and control the electrostatic desalter mechanism 2000. The data measurements are classified as either binary or continuous. Examples of a binary data set include a pass or fail criteria. Continuous data includes measurements such as temperature, pressure, voltage, etc.

In the embodiment of FIG. 2, the controller 2110 collects measurements of the desalted crude oil output product through the controllable flow control valve 2190 and the measurement station 2200. The product measurements made under the control of the controller 2110 are made at random or, preferably, regular intervals. If the desalting process includes a customer specification for any measurement either individually or in combination with others, each applicable measurement is compared to the specification to determine if the sample is within the customer required limits. If the specification is not met, immediate corrective action is taken per the customers' requirements. The product data measurements made under the control of the controller 2110 are also used under the present invention to compute statistical quantifiers for use by the controller 2110 to signal potential problems with and control the electrostatic desalter mechanism 2000. The product data measurements are classified as either binary or continuous in the same manner as the intra-process data measurements.

Based upon the type of crude oil being processed, the controller 2110 can adjust various factors of the desalting operation including but not limited to the following:

The crude oil supply 2010 feed rate through the controllable pump 2070 and controllable flow control valve 2120

The temperature of the crude oil supply 2010 through the controllable heater 2130.

Control of the dehydration mechanism 2310 water level and oil layers through the liquid level sensor 2340, the controllable flow control valve 2330, and the controllable flow control valve 2360.

The dehydration mechanism 2310 electric field through the controllable power supply 2300.

The solution mixture of acid additive 2030 and wash water 2020 through the controllable fluid mixer 2040.

The flow rate of the solution mixture of acid additive 2030 and wash water 2020 through the controllable pump 2050 and controllable flow control valve 2060.

The emulsion formation through controllable fluid mixer 2350.

The electrostatic desalter 2170 electric field through the controllable electrical power supply 2150.

Control of the electrostatic desalter 2170 water level and emulsion layers through the liquid level sensor 2210, the controllable flow control valve 2220, and the controllable flow control valve 2190.

As different crude oils are processed by the desalting mechanism 2000, the characteristics necessary to efficiently desalt the crude oil will require some adjustment. Additionally, differences in dehydration mechanism 2310 characteristics, electrostatic desalter 2170 characteristics, wash water supply 2020 purity, etc between different desalting mechanisms 2000 require the storage of different control settings. The memory/data storage 2100 function of the desalting mechanism 2000 allows the controller to access and update, if required, the control settings required to efficiently process various types of crude oil supplies 2010.

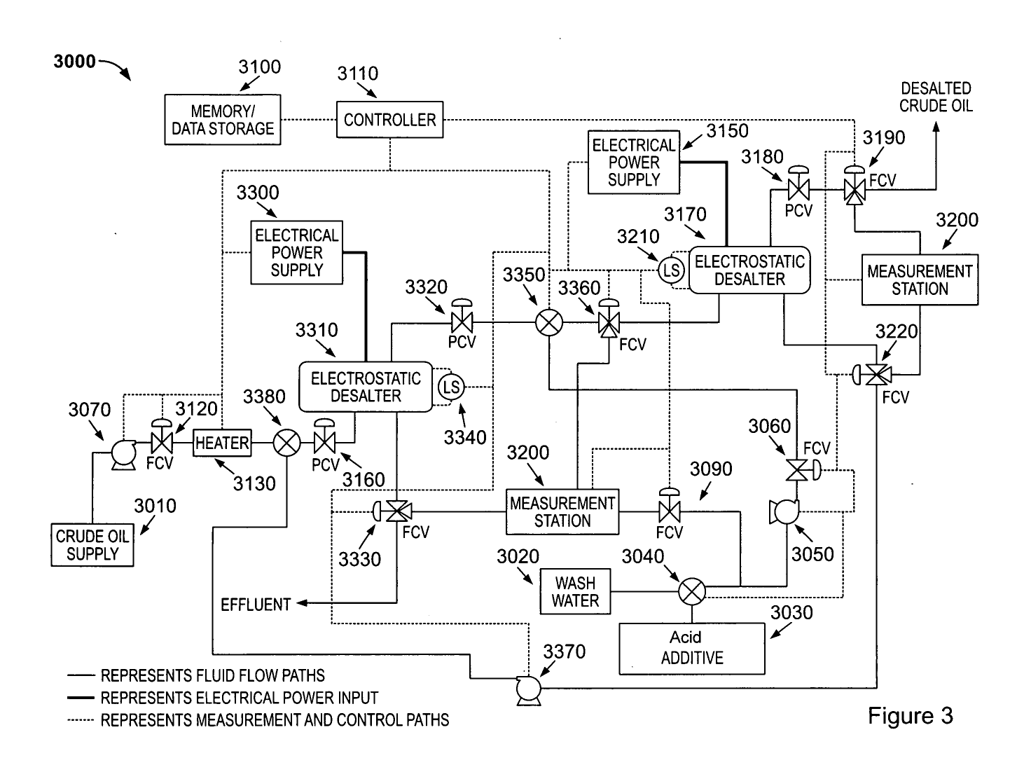

FIG. 3 shows a diagram of a typical two stage electrostatic desalting mechanism 3000 of the present invention.

The desalting mechanism 3000 of the present invention includes a crude oil supply 3010 for storing crude oil. The crude oil supply 3010 is connected to a controllable pump 3070 whose output is connected to a controllable flow control valve (FCV) 3120. The controllable flow control valve 3120 and the controllable pump 3070 work in conjunction under command of the controller 3110 to control and maintain the crude oil feed rate and pressure. The crude oil 3010 is heated to a desired processing temperature by the heater 3130 which is controlled by controller 3110. In the embodiment of FIG. 3, the heated crude oil is mixed with recycled effluent from the electrostatic desalter 3170 to create an emulsion mix of the crude oil supply 3010 and recycled effluent from the electrostatic desalter 3170 via the controllable fluid mixer 3380. Use of an effluent recycle as indicated in FIG. 3 is well-known in the art. The crude oil/effluent recycle emulsion passes through a pressure control valve 3160 before entering the electrostatic desalter 3310. The electrostatic desalter 3310 includes a liquid level sensor (LS) 3340 used to measure the aqueous level in the electrostatic desalter 3310. In the embodiment of FIG. 3, the measurement output of the liquid level sensor 3340 is routed to the controller 3110. The controller 3110 uses the liquid level measurement data to control the controllable flow control valve 3330 to drain the waste effluent from the electrostatic desalter 3310 and control the aqueous layer and emulsion layer within the electrostatic desalter 3310. Alternatively, the liquid level sensor 3340 output may be directly connected to a level control valve instead of the controllable flow control valve 3330 to drain the waste effluent. The controllable flow control valve 3330 is also configured to allow samples of the waste effluent solution to be measured at a measurement station 3200. Measurements made on the solution samples would include but not be limited to solution pH, solution impurity levels, temperature, and amount of residual oil present in the waste effluent. This information is sent to the controller 3110.

The electrical power supply 3300 provides the voltage necessary to create the electric field necessary for electrostatic coalescence in the electrostatic desalter 3310. The controller 3110 controls the electrical power supply 3300 output. The electrical power supply 3300 output may be static (i.e. constant voltage with a current limit) or, preferably, able to change key parameters to enhance the electrostatic coalescence operation. The electrical power supply 3300 under the control of the controller 3110 would preferably be able to alter its' output to include but not be limited to changes in the voltage level applied to the electrostatic desalter 3310, the voltage waveform applied to the desalter, current limits (if any) on the electrical power supply 3300, or any combination thereof.

The crude output of the electrostatic desalter 3310 passes through a pressure control valve 3320 on its way to the controllable fluid mixer 3350. The controllable fluid mixer 3350 allows a second emulsion of electrostatic desalter 3310 output, wash water 3020, and acid additive 3030 to be created based upon the specific characteristics of the crude oil supply 3010 to be desalted. The controllable fluid mixer 3350 is controlled by the controller 3110 to create and maintain the proper emulsion mix of crude oil 3010, wash water 3020, and acid additive 3030.

The desalting mechanism 3000 of the present invention also includes a wash water supply 3020 and an acid additive supply 3030. In the embodiment of FIG. 3, as is preferred, the acid additive 3030 is mixed with the wash water 3020 by the controllable fluid mixer 3040 before the crude oil/wash water emulsion is formed. Alternatively, the acid additive 3030 could be mixed with the wash water 3020 and crude oil 3010 during the emulsion creation or after emulsion creation or with the crude oil 3010 itself. The fluid mixer 3040 is controlled by the controller 3110 to create and maintain the proper solution mixture of acid additive 3030 and wash water 3020. The acid additive 3030 can be selected from the group consisting of oxalic acid, citric acid, glycolic acid, gluconic acid, C.sub.2-C.sub.4 alpha-hydroxy acids, malic acid, lactic acid, poly-hydroxy carboxylic acids, thioglycolic acid, chloroacetic acid, polymeric forms of the above hydroxyacids, poly-glycolic esters, glycolate ethers, and ammonium salt and alkali metal salts of these hydroxyacids, and mixtures thereof.

After mixing the solution of acid additive 3030 and wash water 3020 with the controllable fluid mixer 3040, the resulting solution is input to a controllable flow control valve 3090 which is used to allow samples of the mixed acid additive 3030 and wash water 3020 solution to be measured at a measurement station 3200. Measurements made on the solution samples would include but not be limited to solution pH, solution impurity levels, and percentage of acid additive 3030 to wash water 3020. This information is sent to the controller 3110.

After mixing the solution of acid additive 3030 and wash water 3020 with the controllable fluid mixer 3040, the resulting solution is also input to a controllable pump 3050 whose output is connected to a controllable flow control valve 3060. The controllable pump 3050 and the flow control valve 3060 work in conjunction under the command of the controller 3110 to control and maintain the wash water/acid solution feed rate and pressure. The output of the flow control valve 3060 is an input to the controllable fluid mixer 3350 where the second emulsion of electrostatic desalter 3310 output, wash water 3020, and acid additive 3030 is formed.

After mixing the second emulsion in the controllable fluid mixer 3350, the second emulsion passes through a controllable flow control valve 3360 before entering the electrostatic desalter 3170. The controllable flow control valve 3360, under command of the controller 3110, controls the flow rate of the second emulsion into the electrostatic desalter 3170 as well as allowing samples of the emulsion to be directed to the measurement station 3200. Measurements made on the solution samples would include but not be limited to impurity levels, temperature, amount of acid additive 3030 and wash water 3020 solution, etc. This information is sent to the controller 3110.

The electrostatic desalter 3170 includes a liquid level sensor (LS) 3210 used to measure the aqueous level in the electrostatic desalter 3170. In the embodiment of FIG. 3, the measurement output of the liquid level sensor 3210 is routed to the controller 3110. The controller 3110 uses the liquid level measurement data to control the controllable flow control valve 3220 to recycle the effluent from the electrostatic desalter 3170 and control the aqueous layer and emulsion layer within the electrostatic desalter 3170. Alternatively, the liquid level sensor 3210 output may be directly connected to a level control valve instead of the controllable flow control valve 3220 to recycle the effluent. The controllable flow control valve 3220 along with the controllable pump 3370, under command of the controller 3110, control and maintain the recycled effluent flow rate and pressure to the controllable mixer 3380. The controllable flow control valve 3220 is also configured to allow samples of the effluent solution to be measured at a measurement station 3200. Measurements made on the solution samples would include but not be limited to solution pH, solution impurity levels, temperature, and amount of residual oil present in the effluent. This information is sent to the controller 3110.

The electrical power supply 3150 provides the voltage necessary to create the electric field necessary for electrostatic coalescence in the electrostatic desalter 3170. The controller 3110 controls the electrical power supply 3150 output. The electrical power supply 3150 output may be static (i.e. constant voltage with a current limit) or, preferably, able to change key parameters to enhance the desalting operation. The electrical power supply 3150 under the control of the controller 3110 would preferably be able to alter its' output to include but not be limited to changes in the voltage level applied to the electrostatic desalter 3170, the voltage waveform applied to the electrostatic desalter 3170, current limits (if any) on the electrical power supply 3150, or any combination thereof.

The desalted crude output of the electrostatic desalter 3170 passes through a pressure control valve 3180 and a controllable flow control valve 3190. The controllable flow control valve 3190 has two outputs to direct the desalted crude oil. Under control of the controller 3110, the controllable flow control valve 3190 controls and maintains the flow rate of desalted crude oil to the remaining refinery operations. Additionally, under control of the controller 3110, the controllable flow control valve 3190 can also direct samples of the desalted crude to the measurement station 3200. Measurements made on the solution samples would include but not be limited to impurity levels, temperature, residual acid additive 3030 and wash water 3020 solution, etc. This information is sent to the controller 3110.

In the embodiment of FIG. 3, the controller 3110 takes measurements including but not limited to the various points described herein to evaluate the efficiency of the desalting mechanism 3000. The measurement points can be divided into two data types: intra-process data and product data. Intra-process data include factors that have an impact in the results of the final product, but are not measurements of the final product. Product data are measurements of the final product.

In the embodiment of FIG. 3, the controller 3110 collects measurements from a number of intra-process data points including but not limited to the following:

The crude oil supply 3010 feed rate through the flow control valve 3120.

The temperature, viscosity, and density of the crude oil supply 3010 through the controllable heater 3130.

The electrostatic desalter 3310 water level and emulsion layer through the liquid level sensor 3340.

The characteristics of the electrostatic desalter 3310 effluent through the controllable flow control valve 3330 and the measurement station 3200.

The characteristics of the electrostatic desalter 3310 electric field through the electrical power supply 3300.

The acid additive 3030 and wash water 3020 feed rate through the controllable flow control valve 3060.

The characteristics of the solution mixture of acid additive 3030 and wash water 3020 through the controllable flow control valve 3090 and measurement station 3200.

The characteristics of the wash water 3020/acid additive 3030/crude oil 3010 emulsion through the controllable flow control valve 3360 and measurement station 3200.

The electrostatic desalter 3170 water level and emulsion layer through the liquid level sensor 3210.

The characteristics of the electrostatic desalter 3170 effluent through the controllable flow control valve 3220 and the measurement station 3200.

The characteristics of the electrostatic desalter 3170 electric field through the electrical power supply 3150.

The intra-process measurements made under the control of the controller 3110 are made at random or, preferably, regular intervals while processing the crude supply 3010. If the desalting process includes a customer specification for any intra-process measurement, each applicable measurement is compared to the specification to determine if the sample is within the customer required limits. If the specification is not met, immediate corrective action is taken as per the customers' requirement.

The intra-process data measurements made under the control of the controller 3110 are used under the present invention to compute statistical quantifiers for use by the controller 3110 to signal potential problems with and control the electrostatic desalter mechanism 3000. The data measurements are classified as either binary or continuous. Examples of a binary data set include a pass or fail criteria. Continuous data includes measurements such as temperature, pressure, voltage, etc.

In the embodiment of FIG. 3, the controller 3110 collects measurements of the desalted crude oil output product through the controllable flow control valve 3190 and the measurement station 3200. The product measurements made under the control of the controller 3110 are made at random or, preferably, regular intervals. If the desalting process includes a customer specification for any measurement either individually or in combination with others, each applicable measurement is compared to the specification to determine if the sample is within the customer required limits. If the specification is not met, immediate corrective action is taken per the customers' requirements. The product data measurements made under the control of the controller 3110 are also used under the present invention to compute statistical quantifiers for use by the controller 3110 to signal potential problems with and control the electrostatic desalter mechanism 3000. The product data measurements are classified as either binary or continuous in the same manner as the intra-process data measurements.

Based upon the type of crude oil being processed, the controller 3110 can adjust various factors of the desalting operation including but not limited to the following:

The crude oil supply 3010 feed rate through the controllable pump 3070 and controllable flow control valve 3120

The temperature of the crude oil supply 3010 through the controllable heater 3130.

Control of the electrostatic desalter 3310 aqueous level and emulsion layers through the liquid level sensor 3340, the controllable flow control valve 3330, and the controllable flow control valve 3360.

The electrostatic desalter 3310 electric field through the controllable power supply 3300.

The solution mixture of acid additive 3030 and wash water 3020 through the controllable fluid mixer 3040.

The flow rate of the solution mixture of acid additive 3030 and wash water 3020 through the controllable pump 3050 and controllable flow control valve 3060.

The first emulsion formation of crude oil supply 3010 and recycled effluent from electrostatic desalter 3170 through controllable flow control valve 3220, controllable pump 3370, and controllable fluid mixer 3380.

The second emulsion formation through controllable fluid mixer 3350.

The electrostatic desalter 3170 electric field through the controllable electrical power supply 3150.

Control of the electrostatic desalter 3170 water level and emulsion layers through the liquid level sensor 3210, the controllable flow control valve 3220, and the controllable flow control valve 3190.

As different crude oils are processed by the desalting mechanism 3000, the characteristics necessary to efficiently desalt the crude oil will require some adjustment. Additionally, differences in electrostatic desalter 3310 and 3170 characteristics, wash water supply 3020 purity, etc between different desalting mechanisms 3000 require the storage of different control settings. The memory/data storage 3100 function of the desalting mechanism 3000 allows the controller to access and update, if required, the control settings required to efficiently process various types of crude oil supplies 3010. Preferably, the control settings are determined based upon maximizing the economic benefit for the desalting the crude oil supply 3010.

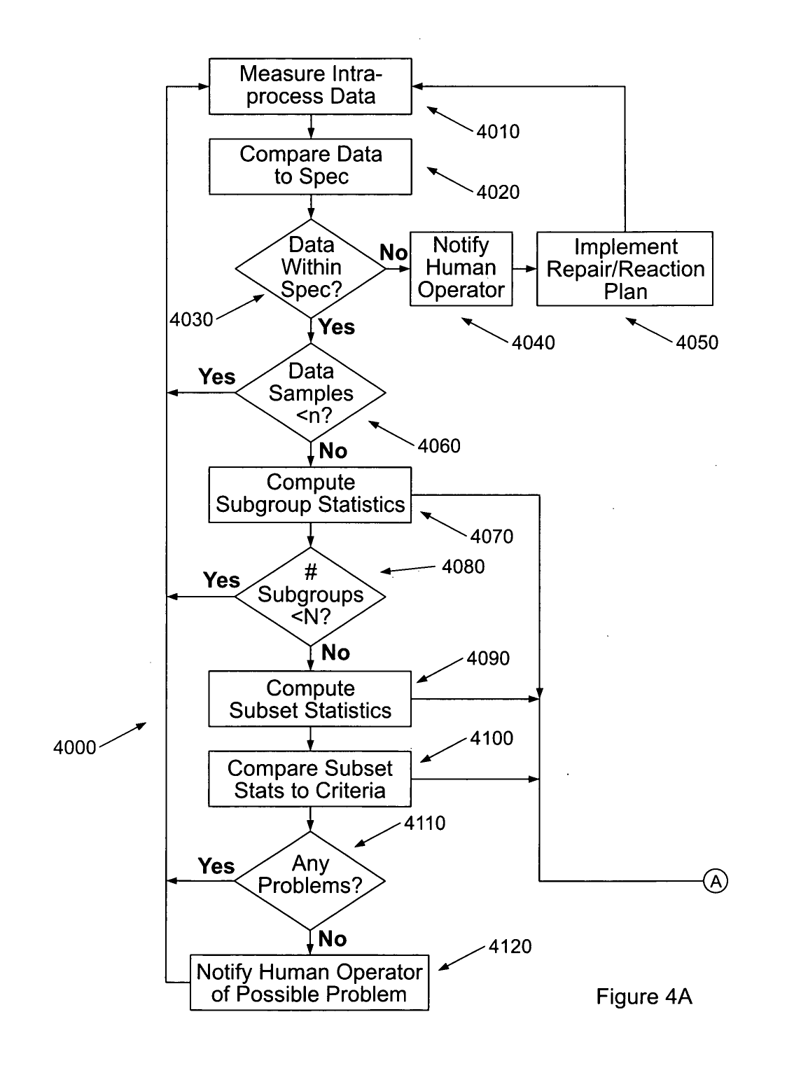

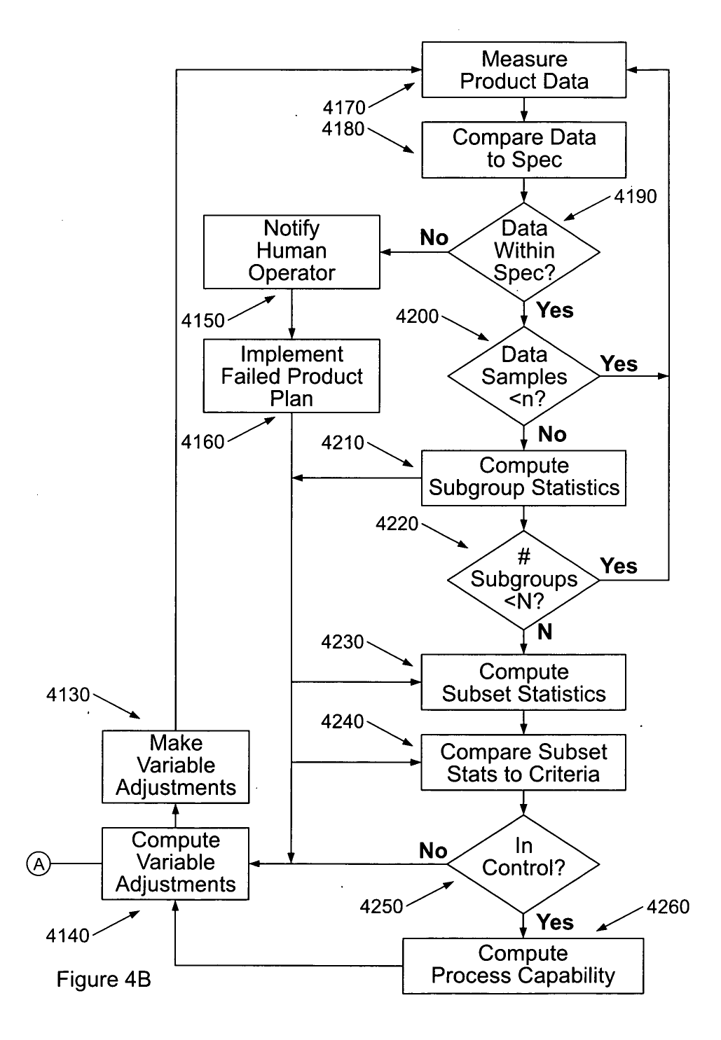

FIG. 4 shows a process flow diagram of one embodiment of the control algorithm 4000 of the present invention for a typical crude oil desalting operation. The intra-process data is measured in step 4010. The intra-process data may include but not be limited to the crude oil feed rate, the crude oil temperature, viscosity, and density, the characteristics of the electrostatic desalter effluent, the electrostatic desalter water level and emulsion layer, the characteristics of the electrostatic desalter electric field, the acid additive feed rate, the wash water feed rate, the characteristics of the wash water/acid additive/crude oil emulsion, et al. During step 4010, the intra-process data may be measured at random or, preferably, regular intervals such that the measurements cover the frequency of potential sources of variation. As the intra-process data is collected, it is compared to any applicable specification or customer requirement in step 4020. Decision step 4030 determines whether or not the applicable intra-process data met the customer requirements. If not, a human operator is notified in step 4040. In step 4050, the repair/reaction plan is implemented to repair the failed sensor, piece of equipment, etc. that caused the intra-process data measurement 4010 to fail. After the repair/reaction plan of step 4050 has been executed, the intra-process data is measured again in step 4010. If the decision step 4030 results in all applicable intra-process data measurements meeting the customer requirements, then the intra-process data is separated into their applicable measurement subsets to form a subgroup and the number of data points in each subset subgroup is compared to the appropriate subgroup size, n, in step 4060. As an example, if we assume that the crude oil flow rate, crude oil temperature, and electrostatic desalter water level are all measured in step 4010, then there will be a crude oil flow rate data subset, a crude oil temperature data subset, and an electrostatic desalter water level data subset. Step 4060 compares the number of data samples in each subset subgroup to the required number of samples, n, needed for each subset subgroup. Each subset subgroup may have a different requirement for the number of samples, n. If, in step 4060, the number of data points in a subset subgroup is less than the number, n, that is required, then the intra-process data is measured again in step 4010. If, in step 4060, the number of subset subgroup data points equals the required number of samples, n, then the subgroup statistics are computed in step 4070. The statistics computed in step 4070 are made on continuous data and depend upon the number of samples in the subset subgroup. Preferably, the intra-process measurements collected in step 4010 are continuous. If the number of subset subgroup samples is one, there is no calculation to be made in step 4070. If the number of subset subgroup samples is greater than one, there are three calculations that may be made. The subset subgroup sample mean is computed as

$${M}_{A} = \frac{{\sum }_{i = 1}^{n} {x}_{i}}{n}$$

where M_{A} is the sample mean of subset subgroup number A, xᵢ represents the individual subset subgroup measurement values, and n is the number of samples that make up the subset subgroup. The subset subgroup sample standard deviation is computed as

$${σ}_{A} = \sqrt{\frac{{\sum }_{i = 1}^{n} {( {x}_{i} - {M}_{A} )}^{2}}{n - 1}}$$

where σ_{A} is the sample standard deviation of subset subgroup A, M_{A} is the sample mean of subset subgroup number A, xᵢ represents the individual subset subgroup measurement values, and n is the number of samples that make up the subset subgroup. The subset subgroup range is computed as

R_{A}=Max Value({xᵢ})−Min Value({xᵢ})

where R_{A} is the range of the subset subgroup A and {xᵢ} represents the set of subset subgroup measurement values.

Decision step 4080 compares the number of subset subgroups to the required number of subgroups, N, needed for each subset. If, in step 4080, the number of subset subgroups is less than the number, N, that is required, then the intra-process data is measured again in step 4010 for a new subset subgroup. If, in step 4080, the number of subset subgroups equals the required number of subgroups, N, then the subset statistics are computed in step 4090. The computations made in step 4090 depend upon whether or not the intra-process measurement data collected in step 4010 is binary or continuous and the number of subset subgroup samples taken.

If, the data measured in step 4010 is binary (i.e. pass/fail, above or below a threshold value, et al), the subset computations to be made in step 4090 can be based upon either the number of discrete events (i.e. number of values above a threshold per subset subgroup) or the fraction of discrete events (i.e. number of values above a threshold divided by the number of subset subgroup samples). For tracking and controlling the number of discrete events, the average threshold crossing count (ATC) for the subset is computed as

$$ATC = \frac{{\sum }_{i = 1}^{N} {TC}_{i}}{N}$$

where ATC is the average threshold crossing count for the subset, TCᵢ is the threshold crossing count for each subset subgroup, and N is the number of subset subgroups. The average subgroup threshold crossing ratio is computed as

$$ASTC = {\sum }_{i = 1}^{N} \frac{{TC}_{i}}{{n}_{i}}$$

where ASTC is the average subgroup threshold crossing ratio, TCᵢ is the threshold crossing count for each subset subgroup, and nᵢ is the number of samples that make up the particular subset subgroup. The upper and lower control limits are computed as

UL_{ATC}=ATC+3×\sqrt{ATC×(1−ASTC)}

LL_{ATC}=ATC−3×\sqrt{ATC×(1−ASTC)}

where UL_{ATC} is the average threshold crossing count upper limit, LL_{ATC} is the average threshold crossing count lower limit, ATC is the average threshold crossing count for the subset, and ASTC is the average subgroup threshold crossing ratio.

For tracking and controlling the fraction of discrete events, the average subgroup threshold crossing ratio (ASTC) is computed as above along with the upper and lower control limits as

UL_{ASTC}=ASTC+3×\sqrt{ASTC×(1−ASTC)}

LL_{ASTC}=ASTC−3×\sqrt{ASTC×(1−ASTC)}

where UL_{ASTC} is the average subgroup threshold crossing ratio upper limit, LL_{ASTC} is the average subgroup threshold crossing ratio lower limit, and ASTC is the average subgroup threshold crossing ratio. An advantage of using ASTC over ATC for binary data tracking and control is that ASTC allows for a variable sample number, n, for each subgroup while ATC assumes a constant number of samples.

If, the intra-process data measured in step 4010 is continuous, the subset computations to be made in step 4090 may vary based upon the number of subset subgroup data samples, n. If the number of subset subgroup data samples is one (1), then the subset average value is computed as

$${AM}_{1} = {\sum }_{i = 1}^{N} {x}_{i}$$

where AM₁ is the one sample subset average, xᵢ represents the individual subset subgroup measurement values, and N is the number of subset subgroups. The one sample subgroup range is computed as

SRᵢ=|xᵢ−xᵢ₋₁| for i=2 to N

where SRᵢ is the range between the i and (i−1) data value and xᵢ represents the individual subset subgroup measurement values. The subset average range is computed as

$${AR}_{1} = \frac{{\sum }_{i = 2}^{N} {SR}_{i}}{N - 1}$$

where AR₁ is one sample subset average range, SRᵢ represents the subset subgroup ranges, and N is the number of subset subgroups. The upper and lower control limits for the one sample subset average (AM₁) and the one sample subset average range (AR₁) are computed as

UL_{AM1}=AM₁+E₂×AR₁

LL_{AM1}=AM₁−E₂×AR₁

UL_{AR1}=D₄×AR₁

LL_{AR1}=D3×AR₁

where AR₁ is the one sample subset average range, UL_{AM1} is the one sample subset average upper limit, LL_{AM1} is the one sample subset average lower limit, UL_{AR1} is the one sample subset average range upper limit, LL_{AR1} is the one sample subset average range lower limit, the constant D₃ is zero, and the values E₂ and D₄ computed as 2.660 and 3.267, respectively, based upon the theoretical distribution of range values between two samples. If the range, SRᵢ, were computed using more individual sample values and/or the intra-process data measurements collected in step 4010 are not normally distributed, then the values of D₃, E₂, and D₄ may be different.

If, the data measured in step 4010 is continuous and the number of subset subgroup data samples, n, is greater than one (1), then the subset average value is computed as

$$AM = \frac{{\sum }_{A = 1}^{N} {M}_{A}}{N}$$

where AM is the subset average, M_{A} is the sample mean of subset subgroup number A computed in step 4070, and N is the number of subset subgroups. The subset average range is computed as

$$AR = \frac{{\sum }_{A = 1}^{N} {R}_{A}}{N}$$

where AR is the subset average range, R_{A} is the range of the subset subgroup number A computed in step 4070, and N is the number of subset subgroups. The subset average standard deviation is computed as

$$A σ = \frac{{\sum }_{A = 1}^{N} {σ}_{A}}{N}$$

where Aσ is the subset average standard deviation, σ_{A} is the sample standard deviation of subset subgroup number A computed in step 4070, and N is the number of subset subgroups. The upper and lower control limits for the subset average (AM) and the subset average range (AR) when the subset average range is used for tracking and control are computed as

UL_{AM}=AM+A₂×AR

LL_{AM}=AM−A₂×AR

UL_{AR}=D₄×AR

LL_{AR}=D₃×AR

where AM is the subset average, AR is the subset average range, UL_{AM} is the subset average upper limit, LL_{AM} is the subset average lower limit, UL_{AR} is the subset average range upper limit, LL_{AR} is the subset average range lower limit, and A₂, D₃, and D₄ are constants that vary based upon the number of subset subgroup samples, n. Table I, below, provides values for A₂, D₃, and D₄ for subset subgroup sample sizes from 2 to 25 assuming that the intra-process data measurements collected in step 4010 are normally distributed.

TABLE I
Control Limit Values for A₂, D₃, and D₄

| Subset Subgroup | | | |
|---|---|---|---|
| Sample Size, n | A₂ | D₃ | D₄ |
| 2 | 1.880 | 0.000 | 3.267 |
| 3 | 1.023 | 0.000 | 2.574 |
| 4 | 0.729 | 0.000 | 2.282 |
| 5 | 0.577 | 0.000 | 2.114 |
| 6 | 0.483 | 0.000 | 2.004 |
| 7 | 0.419 | 0.076 | 1.924 |
| 8 | 0.373 | 0.136 | 1.864 |
| 9 | 0.337 | 0.184 | 1.816 |
| 10 | 0.308 | 0.223 | 1.777 |
| 11 | 0.285 | 0.256 | 1.744 |
| 12 | 0.266 | 0.283 | 1.717 |
| 13 | 0.249 | 0.307 | 1.693 |
| 14 | 0.235 | 0.328 | 1.672 |
| 15 | 0.223 | 0.347 | 1.653 |
| 16 | 0.212 | 0.363 | 1.637 |
| 17 | 0.203 | 0.378 | 1.622 |
| 18 | 0.194 | 0.391 | 1.608 |
| 19 | 0.187 | 0.403 | 1.597 |
| 20 | 0.180 | 0.415 | 1.585 |
| 21 | 0.173 | 0.425 | 1.575 |
| 22 | 0.167 | 0.434 | 1.566 |
| 23 | 0.162 | 0.443 | 1.557 |
| 24 | 0.157 | 0.451 | 1.548 |
| 25 | 0.153 | 0.459 | 1.541 |

The upper and lower control limits for the subset average (AM) and the subset average standard deviation (Aσ) when the subset average standard deviation is used for tracking and control are computed as

UL_{AMS}=AM+A₃×A_{σ}

LL_{AMS}=AM−A₃×A_{σ}

UL_{Aσ}=B₄×Aσ

LL_{Aσ}=B₃×Aσ

where AM is the subset average, Aσ is the subset average standard deviation, UL_{AMS} is the subset average upper limit, LL_{AMS} is the subset average lower limit, UL_{Aσ} is the subset average standard deviation upper limit, LL_{Aσ} is the subset average standard deviation lower limit, and A₃, B₃, and B₄ are constants that vary based upon the number of subset subgroup samples, n. Table II, below, provides values for A₃, B₃, and B₄ for subset subgroup sample sizes from 2 to 25 assuming that the intra-process data measurements collected in step 4010 are normally distributed.

TABLE II
Control Limit Values for A₃, B₃, and B₄

| Subset Subgroup | | | |
|---|---|---|---|
| Sample Size, n | A₃ | B₃ | B₄ |
| 2 | 2.659 | 0.000 | 3.267 |
| 3 | 1.954 | 0.000 | 2.568 |
| 4 | 1.628 | 0.000 | 2.266 |
| 5 | 1.427 | 0.000 | 2.089 |
| 6 | 1.287 | 0.030 | 1.970 |
| 7 | 1.182 | 0.118 | 1.882 |
| 8 | 1.099 | 0.185 | 1.815 |
| 9 | 1.032 | 0.239 | 1.761 |
| 10 | 0.975 | 0.284 | 1.716 |
| 11 | 0.927 | 0.321 | 1.679 |
| 12 | 0.886 | 0.354 | 1.646 |
| 13 | 0.850 | 0.382 | 1.618 |
| 14 | 0.817 | 0.406 | 1.594 |
| 15 | 0.789 | 0.428 | 1.572 |
| 16 | 0.763 | 0.448 | 1.552 |
| 17 | 0.739 | 0.466 | 1.534 |
| 18 | 0.718 | 0.482 | 1.518 |
| 19 | 0.698 | 0.497 | 1.503 |
| 20 | 0.680 | 0.510 | 1.490 |
| 21 | 0.663 | 0.523 | 1.477 |
| 22 | 0.647 | 0.534 | 1.466 |
| 23 | 0.633 | 0.545 | 1.455 |
| 24 | 0.619 | 0.555 | 1.445 |
| 25 | 0.606 | 0.565 | 1.435 |

After the subset statistics are computed in step 4090, the subset subgroup statistics computed in step 4070 and the subset statistics computed in step 4090 are compared to a set of criteria in step 4100 that are designed to provide evidence of statistical instability in the intra-process data measurements collected in step 4010. Preferably, the indicators of statistical instability provide warnings of adverse process conditions before the process produces intra-process measurements or product that fails the customer specifications.

If the intra-process data measured in step 4010 for a given subset is binary, the calculations made in steps 4070 and 4090 for the subset subgroup threshold crossing counts (TCᵢ), subset average threshold crossing count (ATC), the subset average threshold crossing count upper limit (UL_{ATC}), and the subset average threshold crossing count lower limit (LL_{ATC}) and/or the subset subgroup fractional threshold crossing counts

$$( \frac{{TC}_{i}}{{n}_{i}} ) ,$$

the average subgroup threshold crossing ratio (ASTC), the average subgroup threshold crossing ratio upper limit (UL_{ASTC}), and the average subgroup threshold crossing ratio lower limit (LL_{ASTC}) are compared in step 4100.

If the intra-process data measured in step 4010 for a given subset is continuous and the number of subset subgroup data samples, n, is one (1), then the intra-process data measurements, xᵢ, made in step 4010 and the calculations made in step 4090 for the one sample subset average (AM₁), the one sample subset average upper limit (UL_{AM1}), and the one sample subset average lower limit (LL_{AM1}) are compared in step 4100. Additionally, the calculations made in step 4090 for the one sample subgroup range (SRᵢ), the one sample subset average range (AR₁), the one sample subset average range upper limit (UL_{AR1}), and the one sample subset average range lower limit (LL_{AR1}) are compared in step 4100.

If the intra-process data measured in step 4010 for a given subset is continuous and the number of subset subgroup data samples, n, is greater than one, then either the calculations made using range in step 4070 and step 4090 or the calculations made using the standard deviation in step 4070 and step 4090 are used for comparison in step 4100. The choice of which calculation set (range or standard deviation) can be made based upon the number of subset subgroup samples, n. Preferably, the standard deviation calculation set will be used if the number of subset subgroup samples is greater than or equal to 10. If the range calculations are used in step 4100, then the calculations made in step 4070 and step 4090 for the subset subgroup sample means (M_{A}), the subset average (AM), the subset average upper limit (UL_{AM}), and the subset average lower limit (LL_{AM}) are compared. Additionally, the calculations made in step 4070 and step 4090 for the subset subgroup ranges (R_{A}), the subset average range (AR), the subset average range upper limit (UL_{AR}), and the subset average range lower limit (LL_{AR}) are compared in step 4100.

If the standard deviation calculations are used in step 4100, then the calculations made in step 4070 and step 4090 for the subset subgroup sample means (M_{A}), the subset average (AM), the subset average upper limit (UL_{AMS}), and the subset average lower limit (LL_{AMS}) are compared. Additionally, the calculations made in step 4070 and step 4090 for the subset subgroup sample standard deviation (σ_{A}), the subset average standard deviation (Aσ), the subset average standard deviation upper limit (LL_{Aσ}), and the subset average standard deviation lower limit (UL_{Aσ}) are compared in step 4100.

For each calculation set (such as M_{A}, AM, UL_{AM}, and LL_{AM}), the subset subgroup computations (such as M_{A}) are compared in order (i.e. 1 thru N sequentially) in step 4100 with the corresponding subset average, upper limit, and lower limit. Intra-process data measurements collected in step 4010 that are binary have only one calculation set (either threshold crossing counts or threshold crossing count ratios) while continuous data have two sets (either mean and range or mean and standard deviation) for criteria comparison. The criteria to be applied in step 4100 to provide evidence of potential instability may include, but not be limited to, one or more of the following:

One or more subset subgroup computations are greater than the corresponding subset average upper limit or less than the corresponding subset average lower limit. For instance, if any M_{A} value is greater than UL_{AM} or less than LL_{AM}.

N_{B} consecutive subset subgroup computations exist between the mean and the upper limit or the mean and the lower limit. For instance, if N_{B} was chosen to be 8, this criteria would be breached if there were 8 or more consecutive M_{A} values greater than AM and less than UL_{AM} or less than AM and greater than LL_{AM}. N_{B} must be less than or equal to the number of subgroups, N.

N_{T} consecutive subset subgroup computations continually increase or continually decrease. For instance, if N_{T} was chosen to be 5, this criteria would be breached if M_{N}_{_{T−5}}<M_{N}_{_{T−4}}<M_{N}_{_{T−3}}<M_{N}_{_{T−2}}<M_{N}_{_{T−1}}<M_{N}_{_{T}} or M_{N}_{_{T−5}}>M_{N}_{_{T−4}}>M_{N}_{_{T−3}}>M_{N}_{_{T−2}}>M_{N}_{_{T−1}}>M_{N}_{_{T}}. N_{T} must be less than or equal to the number of subgroups, N.

N_{A} consecutive subset subgroup computations alternate in direction; increasing then decreasing. For instance, if N_{A} was chosen to be 10, this criteria would be breached if;

M_{N}_{_{A−9}}>M_{N}_{_{A−8}}<M_{N}_{_{A−7}}>M_{N}_{_{A−6}}<M_{N}_{_{A−5}}>M_{N}_{_{A−4}}<M_{N}_{_{A−3}}>M_{N}_{_{A−2}}<M_{N}_{_{A−1}}>M_{N}_{_{A}}

or, if

M_{N}_{_{A−9}}<M_{N}_{_{A−8}}>M_{N}_{_{A−7}}<M_{N}_{_{A−6}}>M_{N}_{_{A−5}}<M_{N}_{_{A−4}}>M_{N}_{_{A−3}}<M_{N}_{_{A−2}}>M_{N}_{_{A−1}}<M_{N}_{_{A}}

N_{A} must be less than or equal to the number of subgroups, N.

X out of Y consecutive subset subgroup computations lie in a band between the upper limit and a statistically improbable point below the upper limit or a band between the lower limit and a statistically improbably point above the lower limit such that all of the X points lie in the same band. For instance, if X was chosen to be 2, Y was chosen to be 3, and the band limits were from the limit boundaries and halfway between the limit boundaries and the subset mean, this criteria would be breached if either of the following conditions were true;

$${UL}_{AM} \geq {M}_{A} \geq [ AM + \frac{( {UL}_{AM} - AM )}{2} ] for 2 out of 3 consecutive {M}_{A} values$$

$${LL}_{AM} \leq {M}_{A} \leq [ AM + \frac{( {LL}_{AM} - AM )}{2} ] for 2 out of 3 consecutive {M}_{A} values$$

Y must be less than or equal to the number of subgroups, N.

Other criteria may also be applied to the subset subgroup and subset computations in step 4100 to provide statistical indicators of process instability.

Decision step 4110 determines whether or not the subset subgroup and subset statistics indicate any potential problems with the intra-process functions of the crude oil desalter. If any of the subset comparisons conducted in step 4100 do not meet the chosen criteria, the subset(s) failing the comparisons indicate there may be a problem with one or more elements of the oil desalting process even though the product being produced and/or the intra-process data measurements are within spec. If any of the subset comparisons conducted in step 4100 do not meet the chosen criteria, decision step 4110 directs that a human operator is notified indicating a potential problem with one or more elements of the oil desalting process. In step 4120, the human operator is provided with the data and information indicating the possible problem and a new set of subset subgroup and subset data is collected. If all subset comparisons conducted in step 4100 meet the chosen criteria, there is no indicated problem and a new set of subset subgroup and subset data is collected.

The oil desalting process product data is measured in step 4170. The product data may include but not be limited to the desalted crude oil salt content, basic sediments and water content of the desalted crude oil, the temperature of the desalted crude oil, the density of the desalted crude oil, the viscosity of the desalted crude oil, et al. During step 4170, the product data may be measured at random or, preferably, regular intervals such that the measurements cover the frequency of potential sources of variation. As the product data is collected, it is compared to any application specification or customer requirement in step 4180. Decision step 4190 determines whether or not the measured product data met the customer requirements. If not, a human operator is notified in step 4150. In step 4160, the failed product plan is implemented per the customers requirements based upon the failed measurements. The output of step 4160 is input to step 4140 along with the failed data points for further analysis and action. Step 4140 will compute adjustments to one or more controllable parameters of the oil desalter as well as implement automated reaction functions based upon the product failure which may include a quarantine of the suspect product produced since the last known good product, implementation of on-line repair procedures, statistical analysis to estimate the failure root cause, or, in case of catastrophic failure, automated process shutdown.

If the decision step 4190 results in all applicable product data measurements meeting the customer requirements, then the product data is separated into their applicable product measurement subsets to form a product subgroup and the number of data points in each product subset subgroup is compared to the appropriate product subgroup size, n, in step 4200. As an example, if we assume that the salt content in the desalted crude oil, desalted crude oil temperature, and basic sediments and water content of the desalted crude oil are all measured in step 4170, then there will be a salt content in the desalted crude oil data subset, a desalted crude oil temperature data subset, and a basic sediments and water content data subset. Step 4200 compares the number of data samples in each product subset subgroup to the required number of samples, n, needed for each product subset subgroup. Each product subset subgroup may have a different requirement for the number of samples, n. If, in step 4200, the number of data points in a product subset subgroup is less than the number, n, that is required, then the product data is measured again in step 4170. If, in step 4200, the number of product subset subgroup data points equals the required number of samples, n, then the subgroup statistics are computed in step 4210. The statistics computed in step 4210 are made on continuous data and depend upon the number of samples in the product subset subgroup. Preferably, the product measurements collected in step 4170 are continuous. If the number of product subset subgroup samples is one, there is no calculation to be made in step 4210. If the number of product subset subgroup samples is greater than one, there are three calculations that may be made. The product subset subgroup sample mean is computed as

$${PM}_{A} = \frac{{\sum }_{i = 1}^{n} {y}_{i}}{n}$$

where PM_{A} is the sample mean of product subset subgroup number A, yᵢ represents the individual product subset subgroup measurement values, and n is the number of samples that make up the product subset subgroup. The product subset subgroup sample standard deviation is computed as

$$P {σ}_{A} = \sqrt{\frac{{\sum }_{i = 1}^{n} {( {y}_{i} - {PM}_{A} )}^{2}}{n - 1}}$$

where Pσ_{A} is the sample standard deviation of product subset subgroup A, PM_{A} is the sample mean of product subset subgroup number A, yᵢ represents the individual product subset subgroup measurement values, and n is the number of samples that make up the product subset subgroup. The product subset subgroup range is computed as

PR_{A}=Max Value({yᵢ})−Min Value({yᵢ})

where PR_{A} is the range of the product subset subgroup A and {yᵢ} represents the set of product subset subgroup measurement values.

Decision step 4220 compares the number of product subset subgroups to the required number of subgroups, N, needed for each product subset. If, in step 4220, the number of product subset subgroups is less than the number, N, that is required, then the product data is measured again in step 4170 for a new subset subgroup. If, in step 4220, the number of product subset, subgroups equals the required number of subgroups, N, then the product subset statistics are computed in step 4230. The computations made in step 4230 depend upon whether or not the product measurement data collected in step 4170 is binary or continuous and the number of subset subgroup samples taken.

If, the data measured in step 4170 is binary (i.e. pass/fail, above or below a threshold value, et al), the subset computations to be made in step 4230 can be based upon either the number of discrete events (i.e. number of values above a threshold per subset subgroup) or the fraction of discrete events (i.e. number of values above a threshold divided by the number of subset subgroup samples). For tracking and controlling the number of discrete events, the average threshold crossing count (PATC) for the product subset is computed as

$$PATC = \frac{{\sum }_{i = 1}^{n} {PTC}_{i}}{N}$$

where PATC is the average threshold crossing count for the product subset, PTCᵢ is the threshold crossing count for each product subset subgroup, and N is the number of product subset subgroups. The average product subgroup threshold crossing ratio is computed as

$$PASTC = {\sum }_{i = 1}^{N} \frac{{PTC}_{i}}{{n}_{i}}$$

where PASTC is the average product subgroup threshold crossing ratio, PTCᵢ is the threshold crossing count for each product subset subgroup, and nᵢ is the number of samples that make up the particular product subset subgroup. The upper and lower control limits are computed as

UL_{PATC}=PATC+3×\sqrt{PATC×(1−PATC)}

LL_{PATC}=PATC−3×\sqrt{PATC×(1−PATC)}

where UL_{PATC} is the average product threshold crossing count upper limit, LL_{PATC} is the average product threshold crossing count lower limit, PATC is the average threshold crossing count for the product subset, and PASTC is the average product subgroup threshold crossing ratio.

For tracking and controlling the fraction of discrete events, the average product subgroup threshold crossing ratio (PASTC) is computed as above along with the upper and lower control limits as

UL_{PASTC}=PASTC+3×\sqrt{PASTC×(1−PASTC)}

LL_{PASTC}=PASTC−3×\sqrt{PASTC×(1−PASTC)}

where UL_{PASTC} is the average product subgroup threshold crossing ratio upper limit, LL_{PASTC} is the average product subgroup threshold crossing ratio lower limit, and PASTC is the average product subgroup threshold crossing ratio. An advantage of using PASTC over PATC for binary data tracking and control is that PASTC allows for a variable sample number, n, for each subgroup while PATC assumes a constant number of samples.

If, the product data measured in step 4170 is continuous, the product subset computations to be made in step 4230 may vary based upon the number of product subset subgroup data samples, n. If the number of product subset subgroup data samples is one (1), then the product subset average value is computed as

$${PAM}_{1} = {\sum }_{i = 1}^{N} {y}_{i}$$

where PAM₁ is the one sample product subset average, yᵢ represents the individual product subset subgroup measurement values, and N is the number of product subset subgroups. The one sample product subgroup range is computed as

PSRᵢ=|yᵢ−yᵢ₋₁| for i=2 to N

where PSRᵢ is the range between the i and (i−1) data value and yᵢ represents the individual product subset subgroup measurement values. The product subset average range is computed as

$${PAR}_{1} = \frac{{\sum }_{i = 2}^{N} {PSR}_{i}}{N - 1}$$

where PAR₁ is one sample product subset average range, PSRᵢ represents the product subset subgroup ranges, and N is the number of product subset subgroups. The upper and lower control limits for the one sample product subset average (PAM₁) and the one sample product subset average range (PAR₁) are computed as

UL_{PAM1}=PAM₁+E₂×PAR₁

LL_{PAM1}=PAM₁−E₂×PAR₁

UL_{PAR1}=D₄×PAR₁

LL_{PAR1}=D3×PAR₁

where PAR₁ is the one sample product subset average range, UL_{PAM1} is the one sample product subset average upper limit, LL_{PAM1} is the one sample product subset average lower limit, UL_{PAR1} is the one sample product subset average range upper limit, LL_{PAR1} is the one sample product subset average range lower limit, the constant D₃ is zero, and the values E₂ and D₄ are computed as 2.660 and 3.267, respectively, based upon the theoretical distribution of range values between two samples. If the range, PSRᵢ, were computed using more individual sample values and/or the product data measurements collected in step 4170 are not normally distributed, then the values of D₃, E₂, and D₄ may be different.

If, the product data measured in step 4170 is continuous and the number of subset subgroup data samples, n, is greater than one (1), then the product subset average value is computed as

$$PAM = \frac{{\sum }_{A = 1}^{N} {PM}_{A}}{N}$$

where PAM is the product subset average, PM_{A} is the sample mean of product subset subgroup number A computed in step 4210, and N is the number of product subset subgroups. The product subset average range is computed as

$$PAR = \frac{{\sum }_{A = 1}^{N} {PR}_{A}}{N}$$

where PAR is the product subset average range, PR_{A} is the range of the product subset subgroup number A computed in step 4210, and N is the number of product subset subgroups. The product subset average standard deviation is computed as

$$PA σ = \frac{{\sum }_{A = 1}^{N} P {σ}_{A}}{N}$$

where PAσ is the product subset average standard deviation, Pσ_{A} is the sample standard deviation of product subset subgroup number A computed in step 4210, and N is the number of product subset subgroups. The upper and lower control limits for the product subset average (PAM) and the product subset average range (PAR) when the product subset average range is used for tracking and control are computed as

UL_{PAM}=PAM+A₂×PAR

LL_{PAM}=PAM−A₂×PAR

UL_{PAR}=D₄×PAR

LL_{PAR}=D₃×PAR

where PAM is the product subset average, PAR is the product subset average range, UL_{PAM} is the product subset average upper limit, LL_{PAM} is the product subset average lower limit, UL_{PAR} is the product subset average range upper limit, LL_{PAR} is the product subset average range lower limit, and A₂, D₃, and D₄ are constants that vary based upon the number of product subset subgroup samples, n. Table I provides values for A₂, D₃, and D₄ for product subset subgroup sample sizes from 2 to 25 assuming that the product data measurements collected in step 4170 are normally distributed.

The upper and lower control limits for the product subset average (PAM) and the product subset average standard deviation (PAσ) when the product subset average standard deviation is used for tracking and control are computed as

UL_{PAMS}=PAM+A₃×PAσ

LL_{PAMS}=PAM−A₃×PAσ

UL_{PAσ}=B₄×PAσ

LL_{PAσ}=B₃×PAσ

where PAM is the product subset average, PAσ is the product subset average standard deviation, UL_{PAMS} is the product subset average upper limit, LL_{PAMS} is the product subset average lower limit, UL_{PAσ} is the product subset average standard deviation upper limit, LL_{PAσ} is the product subset average standard deviation lower limit, and A₃, B₃, and B₄ are constants that vary based upon the number of subset subgroup samples, n. Table II provides values for A₃, B₃, and B₄ for product subset subgroup sample sizes from 2 to 25 assuming that the product data measurements collected in step 4170 are normally distributed.

After the product subset statistics are computed in step 4230, the product subset subgroup statistics computed in step 4210 and the product subset statistics computed in step 4230 are compared to a set of criteria in step 4240 that are designed to provide evidence of statistical instability in the product data measurements collected in step 4170. Preferably, the indicators of statistical instability provide warnings of adverse process conditions before the process produces product that fails the customer specifications.

If the product data measured in step 4170 for a given product subset is binary, the calculations made in steps 4210 and 4230 for the product subset subgroup threshold crossing counts (PTCᵢ), product subset average threshold crossing count (PATC), the product subset average threshold crossing count upper limit (UL_{PATC}), and the product subset average threshold crossing count lower limit (LL_{PATC}) and/or the product subset subgroup fractional threshold crossing counts

$$( \frac{{PTC}_{i}}{{n}_{i}} ) ,$$

the average product subgroup threshold crossing ratio (PASTC), the average product subgroup threshold crossing ratio upper limit (UL_{PASTC}), and the average subgroup threshold crossing ratio lower limit (LL_{PASTC}) are compared in step 4240.

If the product data measured in step 4170 for a given product subset is continuous and the number of product subset subgroup data samples, n, is one (1), then the product data measurements, yᵢ, made in step 4170 and the calculations made in step 4230 for the one sample product subset average (PAM₁), the one sample product subset average upper limit (UL_{PAM1}), and the one sample product subset average lower limit (LL_{PAM1}) are compared in step 4240. Additionally, the calculations made in step 4230 for the one sample product subgroup range (PSRᵢ), the one sample product subset average range (PAR₁), the one sample product subset average range upper limit (UL_{PAR1}), and the one sample product subset average range lower limit (LL_{PAR1}) are compared in step 4240.

If the product data measured in step 4170 for a given product subset is continuous and the number of product subset subgroup data samples, n, is greater than one, then either the calculations made using range in step 4210 and step 4230 or the calculations made using the standard deviation in step 4210 and step 4230 are used for comparison in step 4240. The choice of which calculation set (range or standard deviation) can be made based upon the number of product subset subgroup samples, n. Preferably, the standard deviation calculation set will be used if the number of product subset subgroup samples is greater than or equal to 10. If the range calculations are used in step 4240, then the calculations made in step 4210 and step 4230 for the product subset subgroup sample means (PM_{A}), the product subset average (PAM), the product subset average upper limit (UL_{PAM}), and the product subset average lower limit (LL_{PAM}) are compared. Additionally, the calculations made in step 4210 and step 4230 for the product subset subgroup ranges (PR_{A}), the product subset average range (PAR), the product subset average range upper limit (UL_{PAR}), and the product subset average range lower limit (LL_{PAR}) are compared in step 4240.

If the standard deviation calculations are used in step 4240, then the calculations made in step 4210 and step 4230 for the for the product subset subgroup sample means (PM_{A}), the product subset average (PAM), the product subset average upper limit (UL_{PAMS}), and the product subset average lower limit (LL_{PAMS}) are compared. Additionally, the calculations made in step 4210 and step 4230 for the product subset subgroup sample standard deviation (Pσ_{A}), the product subset average standard deviation (PAσ), the product subset average standard deviation upper limit (LL_{PAσ}), and the product subset average standard deviation lower limit (UL_{PAσ}) are compared in step 4240.

For each calculation set (such as PM_{A}, PAM, UL_{PAM}, and LL_{PAM}), the product subset subgroup computations (such as PM_{A}) are compared in order (i.e. 1 thru N sequentially) in step 4240 with the corresponding product subset average, upper limit, and lower limit. Product data measurements collected in step 4170 that are binary have only one calculation set (either threshold crossing counts or threshold crossing count ratios) while continuous data have two sets (either mean and range or mean and standard deviation) for criteria comparison. The criteria to be applied in step 4240 to provide evidence of potential instability may include, but not be limited to, the same or similar criteria identified for step 4100.

Decision step 4250 determines whether or not the product subset subgroup and product subset statistics indicate any potential problems with the product output of the crude oil desalter. If any of the product subset comparisons conducted in step 4240 do not meet the chosen criteria, the product subset(s) failing the comparisons indicate there may be a problem with one or more elements of the oil desalting process even though the product being produced and/or the intra-process data measurements are still within specification. If any of the product subset comparisons conducted in step 4240 do not meet the chosen criteria, decision step 4250 will direct the control flow to step 4140 to compute the necessary variable adjustments necessary to bring the product measurements back within statistical stability.

If the all of the product subset comparisons conducted in step 4240, meet the criteria chosen, decision step 4250 will direct the control flow step 4260 to compute the process capability. Process capability is computed in step 4260 on product subsets that are continuous, the product subset subgroups contain more than one (1) sample, and the underlying product subset subgroup measurements collected in step 4170 for each product subset have a customer specification (upper limit, lower limit, or both). For each product subset meeting these criteria that also used the range calculation set in step 4230, the product subset process standard deviation estimate is computed as

$$P {σ}_{pr} = \frac{PAR}{{d}_{2}}$$

where PAR is the product subset average range computed in step 4230, Pσₚᵣ is the product subset process standard deviation estimate based upon product subset range, and d₂ is a constant that varies based upon the number of product subset subgroup samples, n. If the product subset used the standard deviation calculation set in step 4230, the product subset process standard deviation estimate is computed as

$$P {σ}_{p σ} = \frac{PA σ}{{c}_{4}}$$

where PAσ is the product subset average standard deviation computed in step 4230, Pσ_{pσ} is the product subset process standard deviation estimate based upon product subset standard deviation, and c₄ is a constant that varies based upon the number of product subset subgroup samples, n. Table III, below, provides values for d₂ and c₄ for product subset subgroup sample sizes from 2 to 25 assuming that the product data measurements collected in step 4170 are normally distributed.

TABLE III
Control Limit Values for d₂ and c₄

| Product subset subgroup | | |
|---|---|---|
| sample size, n | d₂ | c₄ |
| 2 | 1.128 | 0.7979 |
| 3 | 1.693 | 0.8862 |
| 4 | 2.059 | 0.9213 |
| 5 | 2.326 | 0.9400 |
| 6 | 2.534 | 0.9515 |
| 7 | 2.704 | 0.9594 |
| 8 | 2.847 | 0.9650 |
| 9 | 2.970 | 0.9693 |
| 10 | 3.078 | 0.9727 |
| 11 | 3.173 | 0.9754 |
| 12 | 3.258 | 0.9776 |
| 13 | 3.336 | 0.9794 |
| 14 | 3.407 | 0.9810 |
| 15 | 3.472 | 0.9823 |
| 16 | 3.532 | 0.9835 |
| 17 | 3.588 | 0.9845 |
| 18 | 3.640 | 0.9854 |
| 19 | 3.689 | 0.9862 |
| 20 | 3.735 | 0.9869 |
| 21 | 3.778 | 0.9876 |
| 22 | 3.819 | 0.9882 |
| 23 | 3.858 | 0.9887 |
| 24 | 3.895 | 0.9892 |
| 25 | 3.931 | 0.9896 |

After the product subset process standard deviation estimates are computed in step 4260, the process capacity is estimated in step 4260 based upon computing a Z value for the product subset relative to the specification limits. For a unilateral or one-sided specification limit, the product subset Z value for normally distributed product data is computed as

$${Z}_{SSSL} = \vert \frac{SL - PAM}{P σ} \vert$$

where Z_{SSSL} is the product subset Z value for a single-sided specification limit, SL represents the product subset specification limit, PAM is the product subset average computed in step 4230, and Pσ is the product subset process standard deviation estimate based either on range or standard deviation computed in step 4260. For a bilateral or two-sided specification limit, the product subset Z values for normally distributed product data are computed as

$${Z}_{USL} = \vert \frac{USL - PAM}{P σ} \vert$$

$${Z}_{LSL} = \vert \frac{LSL - PAM}{P σ} \vert$$

where Z_{USL} is the product subset Z value for the upper specification limit, Z_{LSL} is the product subset Z value for the lower specification limit, USL represents the product subset upper specification limit, LSL presents the product subset lower specification limit, PAM is the product subset average computed in step 4230, and Pσ is the product subset process standard deviation estimate based either on range or standard deviation computed in step 4260.

After the Z values are computed for each product subset in step 4260, an estimate for probability of producing in specification product can be computed through an iterative calculation using the Z values or saving a Z value table in memory. The use of Z value statistics for estimating probability is well known in the art.

Step 4140 computes the adjustments to be made to the controllable parameters of the oil desalter. The adjustments include, but are not limited to, the crude oil feed rate, the crude oil temperature, the wash water feed rate, the wash water and additive solution mix, the temperature of the oil/wash water emulsion, the electrostatic desalter water level, the addition rate of acid additive, and the electric field generated within the electrostatic desalter either individually or in combination. In one embodiment of the present invention, the computations in step 4140 consider the intra-process subset subgroup statistics computed in step 4070, the intra-process subset statistics computed in step 4090, the comparison results of the intra-process subset subgroup and subset statistics in step 4100, the product subset subgroup statistics computed in step 4210, the product subset statistics computed in step 4230, and the comparison results of the product subset subgroup and subset statistics in step 4240. If the product subset and product subset subgroup comparison of step 4240 was determined to be within the control criteria in decision step 4250, the process capability computations of step 4260 are also considered in step 4140. In the embodiment of the present invention, the variables may be adjusted to maintain process control (for instance, an adjustment to a parameter to bring an intra-process measurement within statistical stability) or to maximize the oil desalter's economic benefit. As an example, if the process capability for the oil desalter was estimated to produce within specification product 99.9999% of the time given a set of parameter settings, it may make economic sense to increase the crude oil flow rate such that the oil desalter process capability is reduced to producing within specification product 99.99% while simultaneously increasing the product output for a given period of time.

Step 4130 receives the adjustments computed in step 4140 to the controllable parameters of the oil desalter and implements these adjustments. Following the implementation of the adjustments in step 4130, a new set of product subset subgroup and product subset data is measured in step 4170.

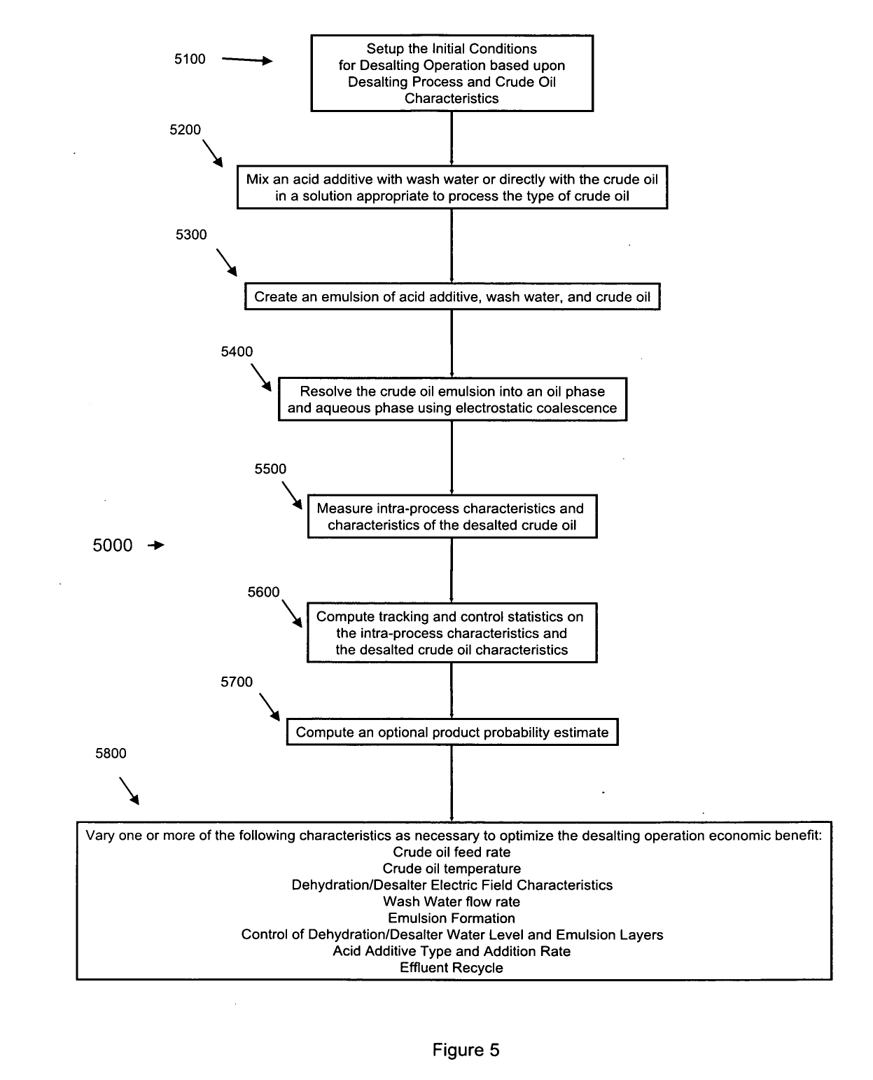

FIG. 5 shows a process diagram 5000 of one embodiment of the method of the present invention for a typical crude oil electrostatic desalting operation implementing automated control. The desalting process is set to an initial state in step 5100 based upon the characteristics of the configuration of the desalting operation and the characteristics of the crude oil to be desalted. An acid additive is mixed with wash water or directly with the crude oil in step 5200. An emulsion of crude oil, wash water, and acid additive is created in step 5300. The emulsion is resolved into a hydrocarbon or oil phase and an aqueous or water phase in step 5400. The intra-process characteristics of the desalting operation that may or may not be dependent upon desalting configuration are measured along with characteristics of the desalted crude oil in step 5500. Tracking and control statistics are computed in step 5600 on the intra-process characteristics and desalted crude oil characteristics measured in step 5500. An optional estimate of the probability of producing desalted crude oil that is within customer specification is computed in step 5700. Characteristics of the desalting operation to include but are not limited to one or more of the following may be varied in step 5800 to maximize the economic benefit of the desalting operation based upon the measurements in step 5500, the statistics computed in step 5600, and the optional probability estimate in step 5700: the crude oil feed rate, the crude oil temperature, the electric field characteristics of the dehydration/desalter mechanisms, the wash water flow rate, the crude oil emulsion formation, control of the dehydration/desalter water levels and emulsion layers, the acid additive type and addition rate, and the effluent recycle (as appropriate).

The above embodiments are merely preferred and the scope of the invention defined by the claims below.

What is claimed is:

1. A method for removing calcium, iron, other metals, and amines from crude oil in a refinery desalting process comprising the steps of:
adding a wash water to the crude oil;
adding the wash water to the crude oil to create an emulsion;
adding to the wash water, the crude oil or the emulsion an acid additive consisting of at least one of the following: oxalic acid, citric acid, water-soluble hydroxyacid selected from the group consisting of glycolic acid, gluconic acid, C.sub.2-C.sub.4 alpha-hydroxy acids, malic acid, lactic acid, poly-hydroxy carboxylic acids, thioglycolic acid, chloroacetic acid, polymeric forms of the above hydroxyacids, poly-glycolic esters, glycolate ethers, and ammonium salt and alkali metal salts of these hydroxyacids, and mixtures thereof;
heating at least one of the crude oil, the wash water or the emulsion to a desired temperature;
resolving the emulsion containing the acid additive into a hydrocarbon phase and an aqueous phase using electrostatic coalescence, the metals and amines being transferred to the aqueous phase;
measuring at least one desalting process characteristic at at least one process point;
performing a statistical calculation of the desalting process performance based upon the measuring; and
adjusting a control setting of the desalting process as a function of the statistical calculation.

2. The method as recited in claim 1 wherein the pH of the wash water, if the acid additive is added to the wash water, is below 6.

3. The method as recited in claim 1 wherein different control settings are stored for different types of crude oil.

4. The method as recited in claim 1 wherein the measuring includes measuring metal or amine impurities in the hydrocarbon or aqueous phase.

5. The method as recited in claim 4 wherein the measuring includes measuring a concentration of calcium.

6. The method as recited in claim 1 wherein the acid additive selected is malic acid.

7. The method as recited in claim 1 wherein the processing characteristic is a temperature of the crude oil.

8. The method as recited in claim 1 wherein the processing characteristic is a crude oil supply feed rate.

9. The method as recited in claim 1 wherein the processing characteristic is a temperature of the emulsion.

10. The method as recited in claim 1 wherein the processing characteristic is a percentage of acid additive to the wash water.

11. The method as recited in claim 1 wherein the processing characteristic is a flow rate of a solution mixture of acid additive and wash water.

12. The method as recited in claim 1 wherein the processing characteristic is an electrostatic desalter electric field.

13. The method as recited in claim 1 wherein the processing characteristic is an electrostatic desalter water or emulsion level.

14. The method as recited in claim 1 further comprising comparing the measured process characteristic to a customer specification.

15. The method as recited in claim 1 wherein the measuring takes place under the control of a controller and the controller adjusts the control setting.

16. The method as recited in claim 1 wherein the measuring includes a continuous measurement.

17. The method as recited in claim 1 wherein the measuring includes a binary measurement.

18. A method for controlling a refinery desalting process comprising the steps of:
measuring at least one desalting process characteristic at at least one process point;
performing a statistical calculation of the desalting process performance based upon the measuring; and
adjusting a control setting of the desalting process as a function of the statistical calculation.

19. A crude oil refinery operating the method as recited in claim 1.

20. An electrostatic desalter comprising:
a crude oil supply for storing crude oil;
a wash water supply for supplying wash water to the crude oil to form an emulsion;
an acid additive supply for supplying an acid additive to the wash water, the emulsion, or the crude oil;
a heater for changing the temperature of the crude oil, the wash water or the emulsion;
pumps and valves for controlling fluid flow in the desalting process; and
a controller monitoring a desalter process characteristic and updating a statistical calculation of the desalter performance based upon the monitoring.
